(19) United States
(12) Patent Application Publication
(10) Pub. No.: US 2008/0297521 A1
(43) Pub. Date: Dec. 4, 2008

(54) SYSTEM AND METHOD FOR PROVIDING SKINS FOR A WEB PAGE

(76) Inventors: Liang-Yu Chi, San Francisco, CA (US); Ashley Hall, Menlo Park, CA (US)

Correspondence Address: YAHOO! INC.;C/O DREIER LLP, 499 PARK AVENUE, NEW YORK, NY, 10022, US

(21) Appl. No.: 11/756,301

(22) Filed: May 31, 2007

(51) Int. Cl. G06F 15/00

(52) U.S. Cl. 345/501

(57) ABSTRACT

The present invention is directed towards systems and methods for dynamically modifying the appearance of a resource based on skins. The method of the present invention comprises building a user skin library based upon user selected skins and receiving requests to change the appearance of a resource from a user. Upon receiving a request, the present invention dynamically updates the appearance of a resource based upon a selected skin.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to customizing an Internet search engine. More specifically, the present invention is directed towards systems and methods for allowing a user to apply a custom skin to an Internet search engine based upon a skin library.

### BACKGROUND OF THE INVENTION

As the amount of users utilizing the World Wide Web rapidly expands, the challenge of maintaining a loyal customer base becomes increasingly difficult. This difficulty is considerable in the business of search engines, as it is easy to view a search engine as merely a stepping stone for a desired resource. Currently, users may not be inclined utilize one search engine over another given the similarity of functions.

Some search engines have attempted to address this concern by adding a variety of different content to their search portals and search results pages. Although this solution addresses a variety of issues regarding customer loyalty, it is not a cure-all. For example, the advantage of providing a user with a news widget installed on a search portal does have the advantage of being a convenience to a user utilizing a search portal; but there is nothing that is stopping a user from retrieving news directly from the source (e.g., a news website). The crux of the problem lies in the solution itself. The data provided in widgets, such as the previously mentioned news widget, is generic; it can be and often is found in a variety of locations (as illustrated by RSS feeds as at least one example). Attempts have further been aimed at narrowing this generic data to meet a particular users needs. For example, a weather widget may ask for a user's zip code and provide local weather. This provides customized content to a user; however, the data presented by the widget may be easily obtained simply by navigating to a weather information provider or by obtaining the information via a non-digital source such television or newspaper.

The above deficiencies are all detrimental to the business of search engines. The rise of sites allowing users to define site metrics (such as social networking sites, sites requiring login, etc.) has shown that users respond to the ability to control how their content is viewed. Traditionally this has been accomplished via the customization of color schemes or similar mechanisms, which fail to provide the user with full control over the customization. There is a need to provide a system for allowing a user to more fully customize his or her experience with an Internet resource such as a search engine. Accordingly, embodiments of the present invention are related to allowing a user to select one or more skins for an Internet search engine and apply these skins to various pages provided by the search engine.

### SUMMARY OF THE INVENTION

The present invention is directed towards systems and methods for dynamically modifying the appearance of a resource based on skins. The method of the present invention comprises building a user skin library based upon user selected skins and receiving requests to change the appearance of a resource from a user. In accordance with one embodiment user selected skins comprise default skins and user-defined skins. The received requested may, in alternative embodiments, be generated in response to user interaction with the resource. In one embodiment, the skin library is stored within a skin data store and skin information is stored within a profile data store.

Upon receiving a request, the present invention dynamically updates the appearance of a resource based upon a selected skin. Receiving a request to change the appearance of a resource may comprise presenting a skin menu to a user, said skin menu comprising a plurality of skin selections. In one embodiment, the skin menu is generated based upon skin information stored within a profile data store. In another embodiment, receiving a request to change the appearance of a resource comprises detecting a user selection of a skin present within a skin menu.

The present invention is further directed towards a system for dynamically modifying the appearance of a resource based on skins. The system of the present invention comprises a plurality of client devices coupled to a network. A content server may be further coupled to said network operative to receive requests to change the appearance of a resource from said client devices and provide resources to said client devices. The requests may be generated in response to a user interaction with a resource.

In one embodiment, receiving a request to change the appearance of a resource comprises presenting a skin menu to a user, said skin menu comprising a plurality of skin selections. In accordance with one embodiment, receiving a request to change the appearance of a resource comprises presenting a skin menu to a user, said skin menu comprising a plurality of skin selections. In an alternative embodiment, receiving a request to change the appearance of a resource comprises detecting a user selection of a skin present within a skin menu.

The system may comprise a skin data store operative to store skin data. The system may also comprise a profile data store operative to store user profile information, wherein said user profile information contains skin data information. A skin logic unit may be further provided, operative to build a skin library based upon user selected skins and further operative to dynamically modify the appearance of a resource provided to a client device. According to various embodiments, user selected skins comprise default skins and user-defined skins.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for providing customized search engine skins to a user according to one embodiment of the present invention;

FIG. 2 presents a flow diagram illustrating a method for generating a customization profile for a user according to one embodiment of the present invention;

FIG. 3 presents a flow diagram illustrating a method for applying a user skin to an Internet search engine according to one embodiment of the present invention;

FIG. 4 presents a screen diagram illustrating an Internet search engine in a user web browser according to one embodiment of the present invention;

FIG. 5 is a screen diagram illustrating a user selecting a search engine skin according to one embodiment of the present invention; and

FIG. 6 is a screen diagram illustrating an Internet search engine after applying a user skin according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

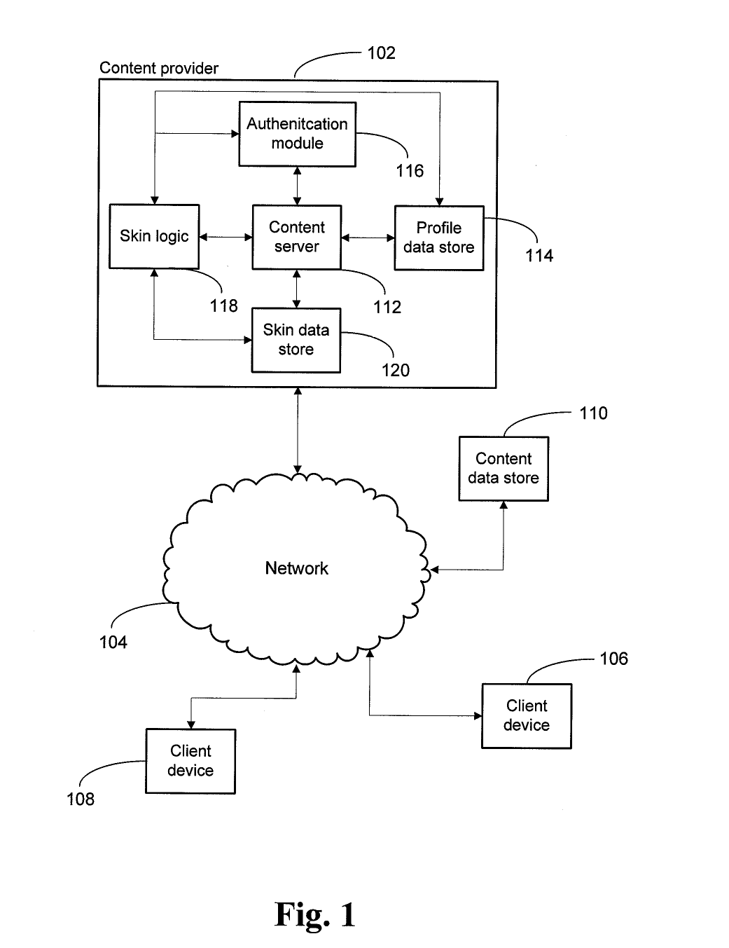

FIG. 1 presents a block diagram illustrating a system for providing customized search engine skins to a user according to one embodiment of the present invention. According to the embodiment illustrated in FIG. 1, one or more client devices 106 and 108 are communicatively coupled to a network 104, which may include a connection to one or more local and wide area networks, such as the Internet. According to one embodiment of the invention, a given client device 106 and 108 is general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A given client device 106 and 108 may be in communication with a content provider 102 that hosts one or more content items. The content provider 102 may maintain one or more content servers 112, a given content server 112 hosting one or more web pages. The content provider 102 may also comprise a repository for the storage and transmission of one or more content items in response to a request from a client device 106 and 108. For example, the content provider 102 may comprise a web site that includes a content server 112 (e.g., Apache™, Internet Information Server™, etc.) and a data store 112, which according to one embodiment is a database that maintains web pages in an organized and structured manner. The content provider 102 may further maintain program code that, when executed by the content provider 102, is operative to dynamically generate one or more content items.

As illustrated in FIG. 1, content provider 102 may comprise a content server 112, a skin data store 120, a profile data store 114, skin logic 118 and an authentication module 116. Content server 112 may be operative to receive a request to update a skin profile for a user from a client device 106 and 108. The content server 112 may further be coupled to an authentication module 116. The content server 112 may communicate with authentication module 116 to verify the identity of a user requesting the use of a user profile and associated skin data located within a profile data store 114 and a skin data store 120, respectively.

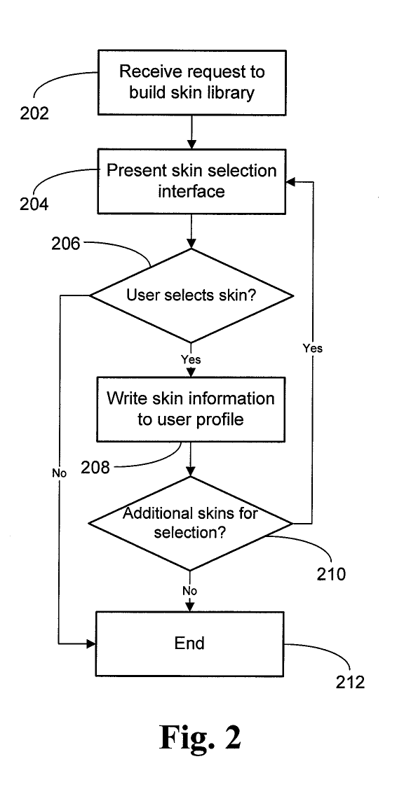

Upon receiving a request to build a skin profile, content server 112 may communicate with skin logic 118 to begin building a skin database within skin data store 120 for a user. As is described in greater detail with respect to FIGS. 2 through 6, a user may submit a request to content server 112 to modify his or her skin library. In accordance with one embodiment, a user may be capable of submitting custom skins via a web-based interface such as an HTML page. Custom skins may be received by skin logic 118, which may perform preprocessing tasks known in the art prior to storing the custom skin within skin data store 120. Skin logic 110 may then access the profile data store 114 to update a user profile associated with the user. Skin logic 110 may add information related to the added skin such as the skin file name, the skin name, skin size and any other information related to the received skin to the user profile stored with profile data store 114. Custom skins that the skin logic is operative to receive include, but are not limited to image files (e.g., JPEG, bitmaps, GIF, etc.) and video files (e.g., WMP, QuickTime, MPEG, etc.).

Skin logic 110 may further be operative to retrieve data from skin data store 120. Content server 112 may be operative to receive a request from a client device 106 and 108 to modify the skin present on a web page viewed on the device. The content server 112 may then send the request to the skin logic 110 which may in turn fetch the desired skin from skin data store 120. The skin logic 110 may further be operative to perform a variety of preprocessing algorithms on the desired skin prior to returning the skin to content server 112. For example, skin logic 110 may resize the skin as needed based on the original skin size, the browser display size or any parameter useful in determining the size of the skin, original skin size, the browser display size or any parameter useful in determining the size of the skin.

FIG. 2 presents a flow diagram illustrating a method for generating a customization profile for a user. As illustrated, a request is received indicating a skin library is to be built, step 202. A request may be in the form of an HTTP request as in response to the selection of a hyperlink or submission of an HTML form, or any similar action known in the art.

In response to a request from a user, a skin selection interface is presented to the user, step 204. In a preferred embodiment, a web-based interface may be presented to a user in response to the selection of a hyperlink or similar action. The web-based interface (such as a static or dynamically generated HTML page) may be the vehicle in which a user may begin the process of creating, modifying or deleting his or her user skin profile.

If a user selects a skin (206), skin information is written to a user profile, step 208. If a user does not select a skin, the process ends 212. In a preferred embodiment, the selection of a skin may comprise selecting a skin from a predefined skin database or selecting a skin from a user defined skin. For example, a user may be able to provide the location of a skin in which they would like to add to their user profile. In an alternative embodiment, a user may be allowed to upload a custom skin from his or her client device. In a preferred embodiment, a skin may comprise an image file such as a file having a .PNG, .GIF, .JPG or any other image format known in the art. In this embodiment, a user defined skin may be located at a third party website (e.g., http://www.myskins.com/orange_skin.png), may be resident on a client device (e.g., /home/user/skins/orange_skin.png) or may be resident on the device providing the skin selection screen (e.g., /htdocs/default_skins/orangeskin.png residing on a server device).

After a user selects a skin, the skin is written to a user profile, step 208. In a preferred embodiment, when a user selects a skin a link may be recorded in the user profile. For example, if a user selects a skin resident on a third party site, a reference to the third party skin may be generated (e.g., Orange Skin=http://www.myskins.com/orange_skin.png stored within a user profile). Alternatively, skins may be stored within a user specific location on the server device. For example, if a user provides a URL to a third party skin, the third party skin may be copied to the server device to aid in access time and to guarantee the reliability of the skin. Additionally, if a user defines a skin resident on their client device, the skin may be uploaded to a server device and stored locally to allow for access from a plurality of alternative devices.

When a user skin is added to a user profile (208) the skin selection interface determines if additional skins are to be selected, step 210. In a preferred embodiment, a user may select multiple skins using the same skin selection interface. If a user decides to select additional skins, the skin selection interface is presented again (204); if not, the process ends (212).

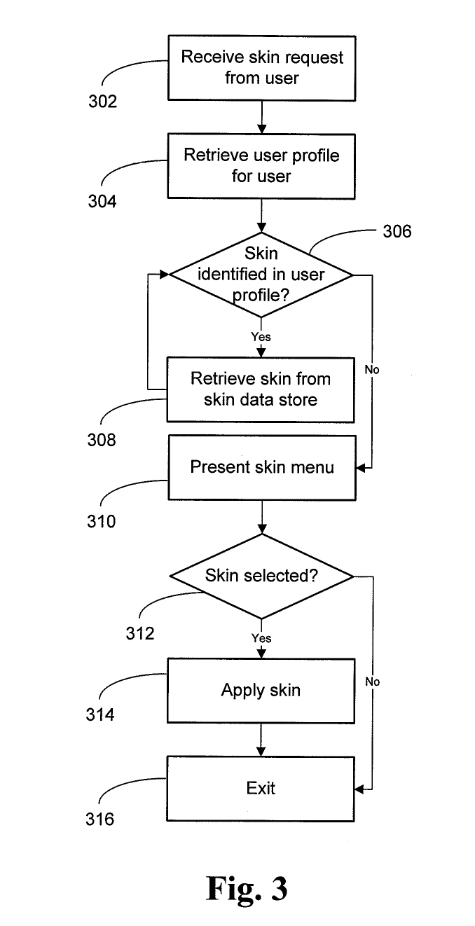

FIG. 3 presents a flow diagram illustrating a method for applying a user skin to an Internet search engine. A first skin request is received from a user, step 302. In a preferred embodiment, a skin request may be generated by a user action, such as selecting an option to modify the current skin of a viewed webpage. After a request is made for a skin, a user profile corresponding to the user may be retrieved, step 304. A user may be identified in a plurality of ways such as by a client-side cookie resident on the client device. When a user requests a skin, this client identifying information is transmitted along with the request to allow a second device to retrieve a user's profile.

Following the retrieval of a user profile, the profile is queried to determine if skins are identified within the user profile, step 306. If it is determined that a skin is present within the user profile, the skin is retrieved from a skin data store, step 308. After the skin is retrieved from a skin data store, the query is performed again. The process of retrieving skins from a skin data store continues until all skins identified within a retrieved user profile are retrieved. After all skins are retrieved, a skin menu is presented to a user, step 310. In a preferred embodiment, a skin menu may comprise and HTML element that is generated in response to a user action. For example, a user may be presented with a hyperlink which, upon interaction, may be operative to generate an HTML element (such as an HTML DIV element) that contains options to change the present skin of a webpage. This element may be similar in spirit to a dropdown menu and thus would ease the use of operation by a user.

If a user selects a skin from the present skin menu (step 312), the skin is applied to the currently viewed resource, step 314. If the user does not select a skin, the process ends with out applying a new skin to the resource, step 316. In a preferred embodiment, the application of skin may result in the replacing of images, such as background images, with the user selected skin. Various methods may be utilized to display a skin on a viewed resource. If a user defined skin does not match logistical requirements of a resource (such as height, width, etc.) the skin may be dynamically modified or presented to provide an aesthetically pleasing display. For example, if a user skin image does not match the width of the default skin, the user skin may be duplicated to fill the remaining empty space. In an alternative embodiment, the user skin may be stretched to fill the entire space. In another embodiment, the image may be aligned to a defined position in the empty skin space and the remainder of the skin space may be filled with an aesthetically pleasing color; this color may be determined by analyzing the user defined skin and choosing an appropriate hue corresponding to the user defined skin. In another embodiment, the empty space may be transformed to match the height and width of the user defined image. In yet another embodiment, the color scheme of a resource may be modified based upon hue analysis of the user defined skin. That is, textual elements, border elements, etc. may be modified in accordance with the user defined skin.

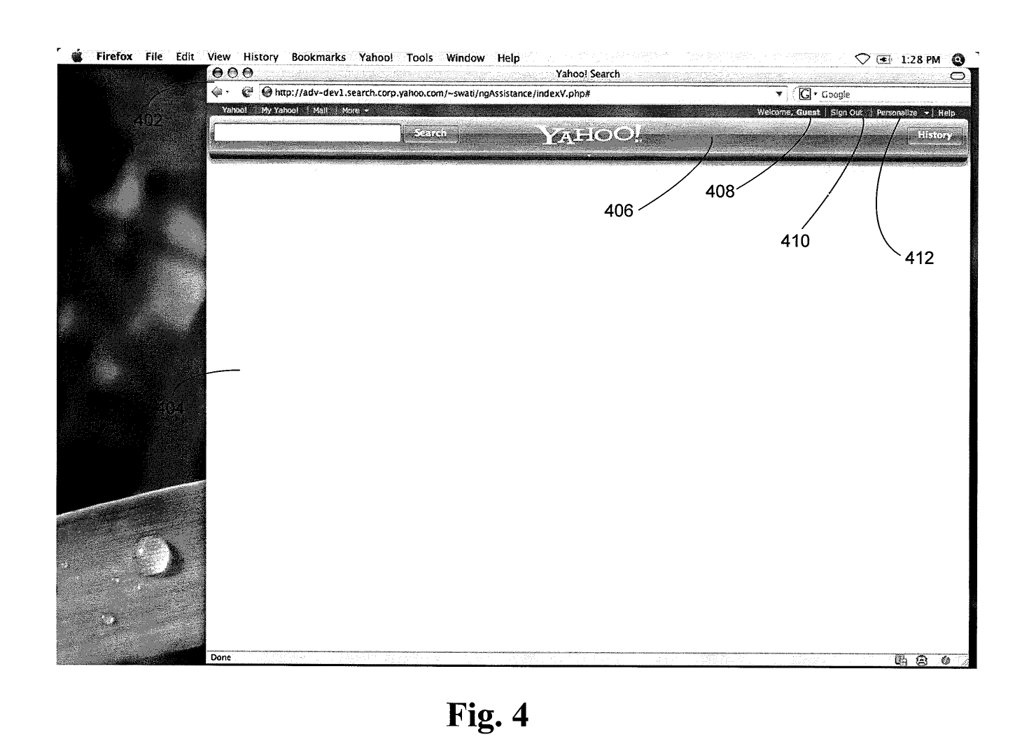

FIG. 4 presents a screen diagram illustrating an Internet search engine in a user web browser. As illustrated, a web browser 402 may be utilized to view a webpage 404. In a preferred embodiment, the webpage 404 may be a webpage associated with a search engine, such as a search results page; although, in other embodiments the webpage 404 may be any webpage that may benefit from the present invention, such as a web portal or any website having “login” functionality or personalized aspects.

Webpage 404 contains a skin element 406. Skin element 406 may be an HTML element such as a DIV element or similar element capable of having a skin applied to itself. Skin element 406 may also comprise a plurality of elements such as a user identification element 408, a sign out element 410 and a personalization element 412.

The user identification element 408 identifies that a user viewing a resource is “logged in” to a resource, that is, the user is alerted that he or she (and their user profile) is known to the server and subsequent webpage. Accordingly, a sign out element 410 may be provided which allows a user to remove their identification from the server. In one embodiment, if a user selects the sign out element 410, the personalization element 412 may be removed, as no profile will exist if the user is not identified. Alternatively, the personalization element 412 may comprise only generic skins if a user is unable to be identified by the server. Alternatively, or in addition to the foregoing, information regarding the identification and assignment of skins may be made through a cookies that the user maintains on his or her client device.

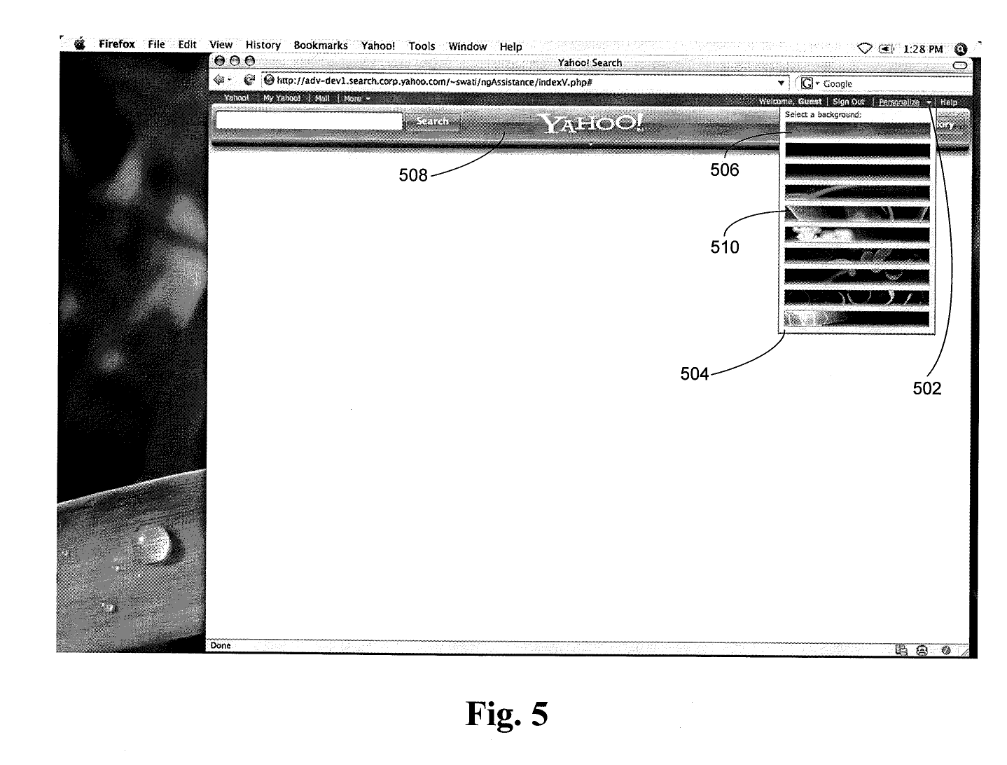

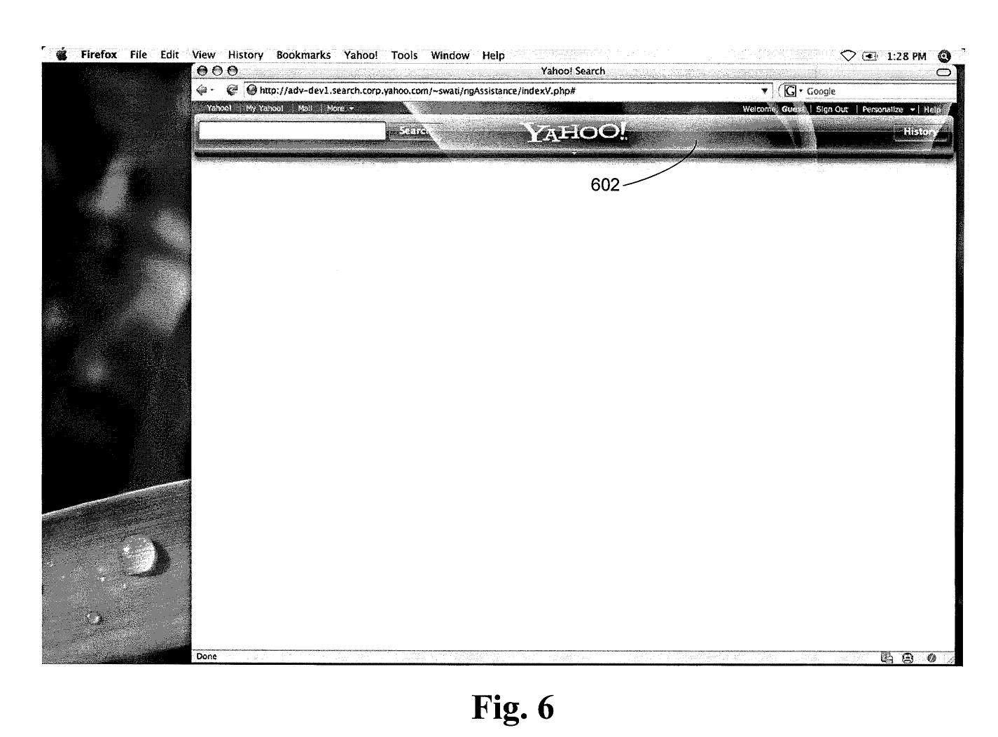

The personalization element 412 allows a user to personalize the currently viewed page. In an alternative embodiment, a personalization element 412 may be persistent in nature and may allow a personalization change to persist across a variety of pages provided by the same server providing the webpage 404. In a preferred embodiment, the personalization element 412 may function by providing a user a drop down menu with personalization options, as will be discussed with respect to FIGS. 5 through 6.

FIG. 5 is a screen diagram illustrating a user selecting a search engine skin. As previously described, a webpage provided by a server contains a skin element 508 that is capable of being re-skinned according to a user interaction.

As illustrated, a skin menu 504 is presented in response to a user selecting a personalization element 502. In a preferred embodiment, skin menu 504 may comprise an HTML DIV element capable of providing additional data to a user. A skin menu 504 may be shown in response to a user interaction via a JavaScript method allowing the element to be appended to the currently viewed resource. In a preferred embodiment, the data contained within the skin menu may be asynchronously retrieved from a server and display on a client device enhancing the performance of the page.

As shown, skin menu 504 contains a plurality of skins 506 and 510. The skins presented within skin menu 504 may comprise thumbnail images of larger skins associated with the current user located on a server device. In the embodiment illustrated in FIG. 5, a user may select a specific skin (510) to dynamically update the appearance of skin element 508.

FIG. 6 is a screen diagram illustrating an Internet search engine after applying a user skin. As mentioned with respect to FIG. 5, a user may select a specific skin 510 from the skin menu 504.

Upon the selection of a skin 510, a skin element 602 is updated to reflect the user change. In the embodiment of FIG. 6, a default background image of skin element 602 is replaced by the user skin 510. In a preferred embodiment, a user selected skin is applied to a skin element 602 via an asynchronous call for the skin. For example, when a request to change the skin of a page is detected, a JavaScript method may submit a request for the desired skin in the background while the page remains on the client device. After the skin is retrieved from an external device, the skin may be applied to the skin element 602 in a seemingly instantaneous fashion due to the nature of the asynchronous calls.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for dynamically modifying the appearance of a resource based on skins, the method comprising:
building a user skin library based upon user selected skins;
receiving a request to change the appearance of a resource from a user; and
dynamically updating the appearance of a resource based upon a selected skin.

2. The method of claim 1, wherein said skins are stored within a skin data store.

3. The method of claim 1 further comprising storing skin information within a profile data store.

4. The method of claim 1, wherein said request is generated in response to a user interaction with said resource.

5. The method of claim 1, wherein receiving a request to change the appearance of a resource comprises presenting a skin menu to a user, said skin menu comprising a plurality of skin selections.

6. The method of claim 5, wherein said skin menu is generated based upon skin information stored within a profile data store.

7. The method of claim 5, wherein receiving a request to change the appearance of a resource comprises detecting a user selection of a skin present within a skin menu.

8. The method of claim 1, wherein said user selected skins comprise default skins and user-defined skins.

9. A system for dynamically modifying the appearance of a resource based on skins comprising:
a plurality of client devices coupled to a network;
a content server coupled to said network operative to receive requests to change the appearance of a resource from said client devices and provide resources to said client devices;
skin logic operative to build a skin library based upon user selected skins and further operative to dynamically modify the appearance of a resource provided to a client device.

10. The system of claim 9, further comprising a skin data store operative to store skin data;

11. The system of claim 9, further comprising a profile data store operative to store user profile information, wherein said user profile information contains skin data information.

12. The system of claim 9, wherein said request is generated in response to a user interaction with said resource.

13. The system of claim 9, wherein receiving a request to change the appearance of a resource comprises presenting a skin menu to a user, said skin menu comprising a plurality of skin selections.

14. The system of claim 13, wherein said skin menu is generated based upon skin information stored within the profile data store.

15. The system of claim 13, wherein receiving a request to change the appearance of a resource comprises detecting a user selection of a skin present within a skin menu.

16. The system of claim 9, wherein said user selected skins comprise default skins and user-defined skins.
